(19) United States
(12) Patent Application Publication
(10) Pub. No.: US 2009/0322666 A1
(43) Pub. Date: Dec. 31, 2009

(54) Driving Scheme for Multiple-fold Gate LCD

(76) Inventor: Guo-Ying Hsu, Tainan (TW)

Correspondence Address: STOUT, UXA, BUYAN & MULLINS LLP, 4 VENTURE, SUITE 300, IRVINE, CA, 92618, US

(21) Appl. No.: 12/147,598

(22) Filed: Jun. 27, 2008

(51) Int. Cl. G09G 3/36

(52) U.S. Cl. 345/96

(57) ABSTRACT

A driving scheme for a multiple-fold gate liquid crystal display (LCD), such as a double gate LCD, is disclosed. A forward driving sequence is provided to drive bank A and bank B of pixel electrodes in a number of rows. Subsequently, a reverse driving sequence is obtained to drive the bank A and the bank B in a number of neighboring rows.

### BACKGROUND OF THE INVENTION

1. Field of the Invention

The present invention generally relates to liquid crystal display (LCD), and more particularly to driving scheme for double gate LCD to effectively reduce the defective vertical stripes.

2. Description of the Prior Art

A liquid crystal display (LCD) typically includes rows and columns of picture elements (or pixels) arranged in matrix form. Each pixel includes a thin film transistor (TFT) and a pixel electrode formed on a substrate (or panel). The gates of the TFTs in the same row are connected together through a gate line, and controlled by a gate driver (or scan driver). The sources of the TFTs in the same column are connected together through a source line, and controlled by a source driver (or data driver). A common electrode is formed on another substrate (or panel). A liquid crystal (LC) layer is sealed between the pixel electrode substrate and the common electrode substrate, and the voltage difference between the pixel electrode and the common electrode determines the display of the pixels. To prevent the LC layer from being deteriorated due to the long-term application of the one-directional electric field, an inversion driving scheme (such as line inversion or dot inversion) is typically employed by pulling up and down the common electrode voltage (Vcom) to periodically reverse the applied electric field.

The gate driver and the source driver are formed with a number of driving integrated circuit (IC) chips, respectively. As the source driving IC chip typically has cost higher than the gate driving IC chip, it is thus advantageous to reduce the number of the source driving IC chips in the LCD, even to increase the number of the gate driving IC chips. Accordingly, some double (or dual) gate LCD structures are disclosed, in which the number of the source lines (and the source driving IC chips) is reduced in half, while the number of the gate lines (and the gate driving IC chips) is doubled. As a whole the double gate LCD generally costs less than the conventional LCD. In the operation of the double gate LCD, the TFTs in the same line are turn on in turn, rather than at the same time as in the conventional LCD, during a cycle of horizontal scan (usually abbreviated as 1H).

Nevertheless, defective vertical stripes often appear on the display of the double gate LCD, due to un-balance charge for adjacent pixels caused by unsettled common electrode voltage (Vcom) resulted from RC loading on the common electrode. This defective vertical stripe phenomenon has been recognized by and mentioned in, for example, US Patent Application No. 2006/0164350 to Kim et al., entitled “Thin Film Transistor Array Panel and Display Device.”

For the foregoing reasons, a need has arisen to propose a novel driving scheme for double gate LCD to effectively reduce or eliminate the defective vertical stripes.

### SUMMARY OF THE INVENTION

In view of the foregoing, it is an object of the present invention to improve display quality by proposing a novel driving scheme for double gate LCD to effectively reduce or even eliminate the defective vertical stripes.

According to the embodiments, the present invention provides a driving scheme for a multiple-fold gate liquid crystal display (LCD), such as a double gate LCD. A forward driving sequence is provided to drive bank A and bank B of pixel electrodes in a number of rows. Subsequently, a reverse driving sequence is provided to drive the bank A and the bank B in a number of neighboring rows. Accordingly, the charge un-balance caused by the toggling common electrode voltage could be visually averaged both spatially and temporally, thereby effectively reducing the defective vertical stripes.

### BRIEF DESCRIPTION OF THE DRAWINGS

FIG. 1A illustrates a double gate liquid crystal display (LCD);

FIG. 1B illustrates a partial circuit diagram of FIG. 1A;

FIG. 1C shows a timing diagram illustrating the operation of FIG. 1A;

FIG. 1D shows a timing diagram illustrating the driving sequence of the gate lines according to driving scheme of FIG. 1C;

FIG. 1E shows exemplary common electrode polarities of a double gate LCD;

FIG. 2A shows a timing diagram illustrating the operation of a driving scheme according to one embodiment of the present invention;

FIG. 2B shows a timing diagram illustrating the driving sequence of the gate lines according to driving scheme of FIG. 2A;

FIG. 2C shows exemplary common electrode polarities according to the driving scheme of FIG. 2A;

FIG. 3A shows a timing diagram illustrating the operation of a driving scheme according to another embodiment of the present invention;

FIG. 3B shows a timing diagram illustrating the driving sequence of the gate lines according to driving scheme of FIG. 3A; and

FIG. 3C shows exemplary common electrode polarities according to the driving scheme of FIG. 3A.

### DETAILED DESCRIPTION OF THE INVENTION

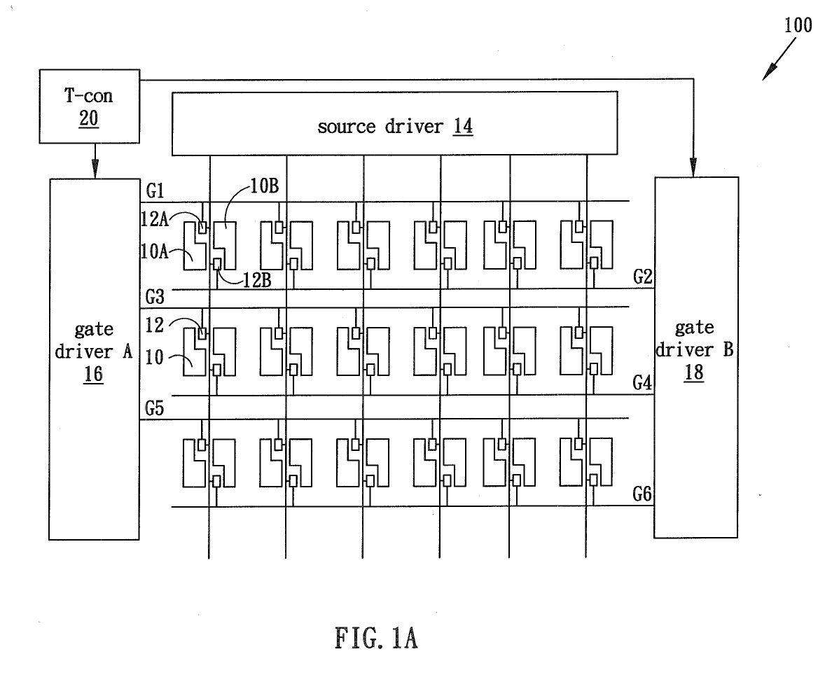

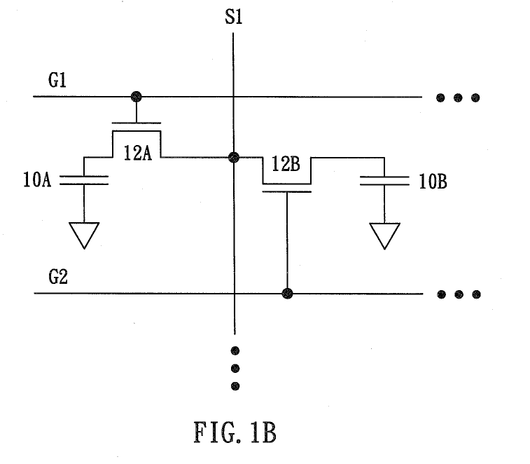

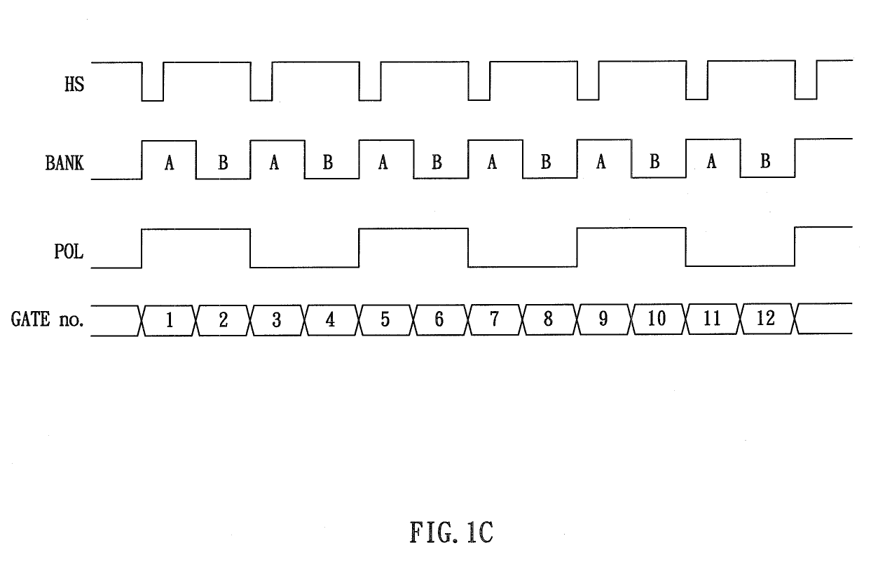

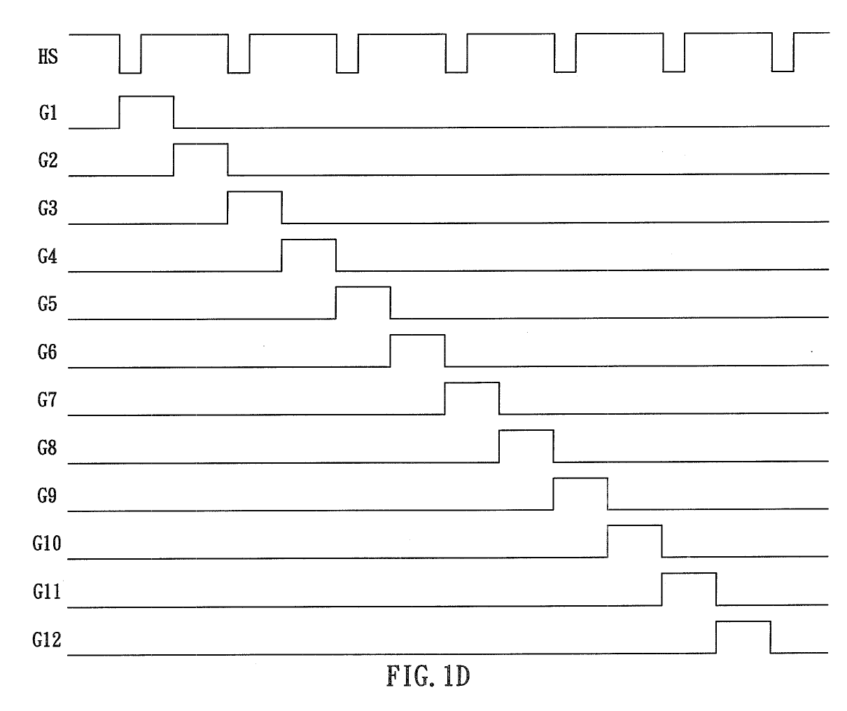

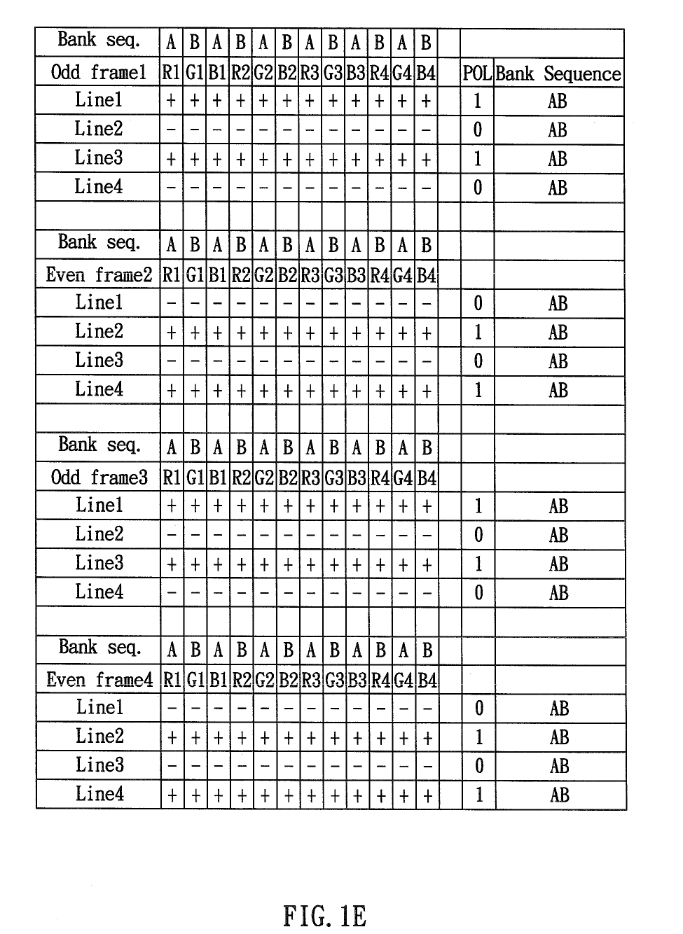

FIG. 1A illustrates a double gate liquid crystal display (LCD) 100, which includes rows and columns of pixel electrodes 10 arranged in matrix form. FIG. 1B illustrates a partial circuit diagram of FIG. 1A. A switching element 12, such as a thin film transistor (TFT) corresponds to each pixel electrode 10 in a picture element (or pixel). In a row, neighboring TFTs (for example, 12A and 12B) share a source line (for example, S1), which is driven by a source driver 14; and the sources of the TFTs (12A and 12B) in the neighboring columns are connected together through the shared source line (S1) as shown in FIG. 1B. In the row, a portion of the TFTs 12 (for example, the odd TFTs) are connected together through a gate line (for example, G1) driven by a gate driver A (16), and other portion of the TFTs 12 (for example, the even TFTs) are connected together through another gate line (for example, G2) driven by another gate driver B (18). These two gate lines form the pair of gate lines for the corresponding row of pixels. It is appreciated by a person skilled in the pertinent art that the gate driver A (16) and the gate driver B (18) may be combined and formed in a single gate driver. For the purpose of illustration, the odd TFTs and corresponding pixel electrodes in the row are called bank A, and the even TFTs and corresponding pixel electrodes in the row are called bank B. A timing controller 20 (or T-con) controllably synchronizes the operation of the gate driver 16/18 and the source driver 14.

FIG. 1C shows a timing diagram illustrating the operation of FIG. 1A. The activation of a horizontal synchronization signal HS from a logic high (“1”) to a logic low (“0”) starts a cycle of horizontal synchronization scan, which is usually abbreviated as 1H. During the 1H cycle, the bank A and the bank B are activated in turn in a pattern of AB-AB-AB-AB, such that the odd pixel electrodes and the even pixel electrodes are activated in turn to receive video data from the source driver 14 through the source lines S1-S6. Repeating this pattern, the first gate line G1 though the last gate line (G12 in the example shown in FIG. 1C) are driven in sequence as shown. Accordingly, the gate lines G1-G12 of the double gate LCD are driven in the sequence of 1-2-3-4-5-6-7-8-9-10-11-12 as shown in FIG. 1D. Referring back to FIG. 1C, the polarity of common electrode POL is inversed to achieve line inversion such that the polarities of scan lines are reversed in sequence in a frame, and the polarity of a scan line is also reversed in sequence through frames. For example, as shown in FIG. 1E, when scan line 1 (“Line1”) has positive polarity (“+”), its neighboring scan line 2 (“Line2”) in the same frame then has negative polarity (“−”). Furthermore, with respect to the same scan line of consecutive frames, its polarity is also reversed in sequence through frames. For example, as shown in FIG. 1E, when scan line 1 (“Line1”) of frame 1 (“frame1”) has positive polarity (“+”), the same scan line 1 of a neighboring frame (“frame2”) then has negative polarity (“−”).

With respect to the double gate LCD driven under the line-inversion driving scheme of FIG. 1C, the common electrode voltage (Vcom) toggles (from logic high to low, or from logic low to high) every horizontal scan (that is, 1H). As the common electrode voltage (Vcom) usually cannot settle down within half horizontal scan (½*H) due to the fact that the slew rate of the common electrode voltage is substantially dominated by the RC loading on the common electrode, the charge on the charge capacitance (for example, 10A or 10B in FIG. 1B) becomes un-balance between the bank A and the bank B, therefore resulting in charge difference between neighboring pixels. As a result, defective vertical stripe or stripes appear on the display of the double gate LCD.

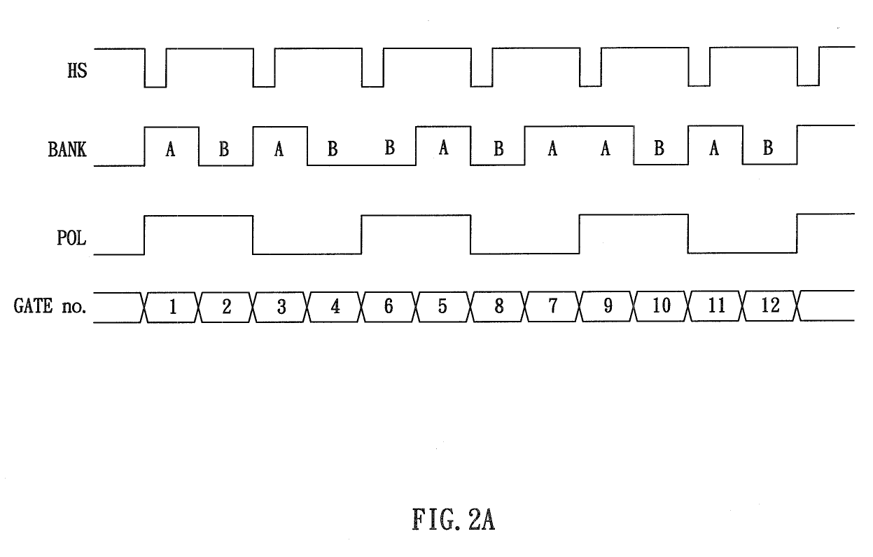

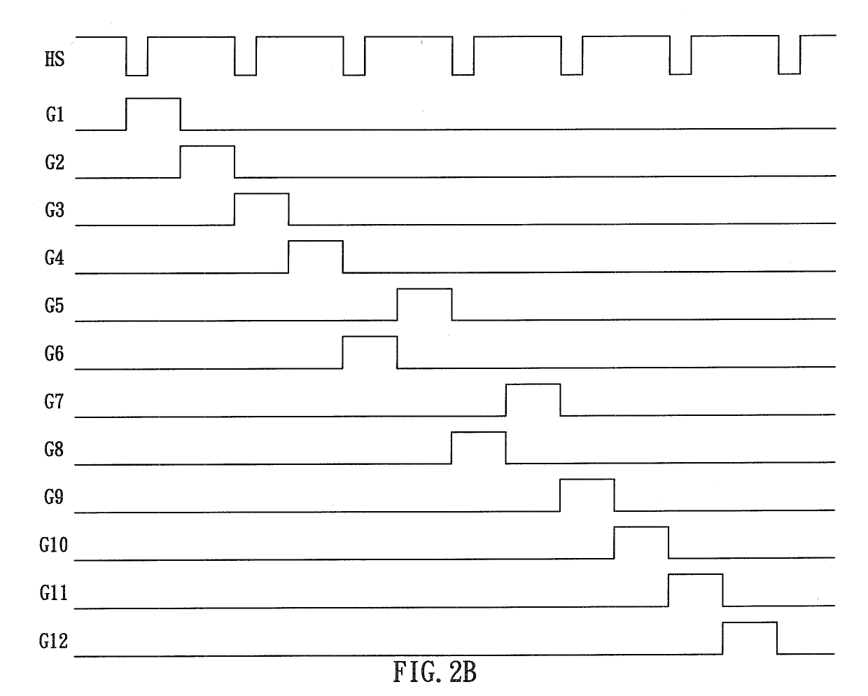

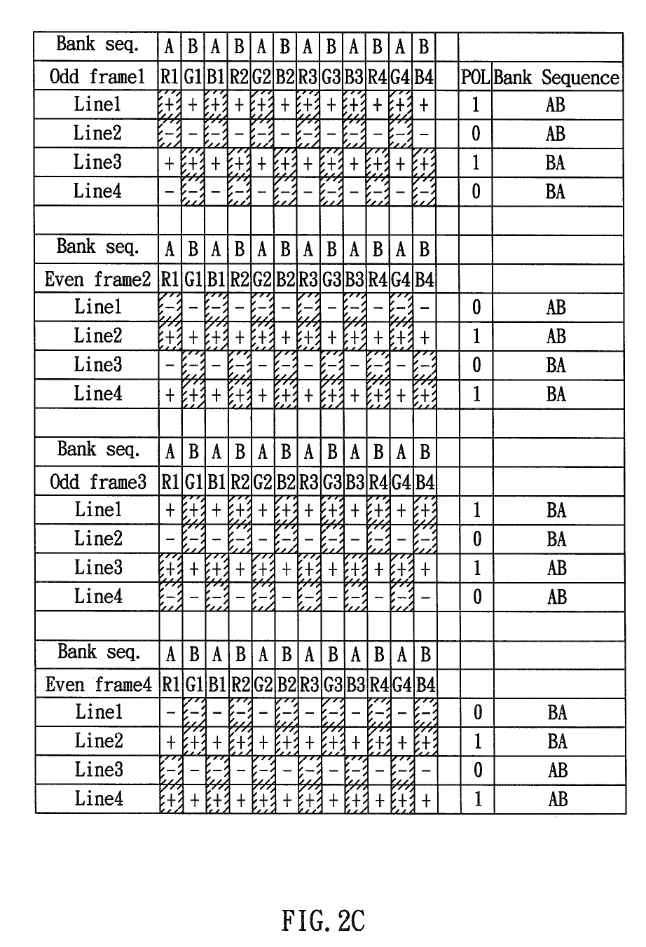

FIG. 2A shows a timing diagram illustrating the operation of a driving scheme for a double gate LCD according to one embodiment of the present invention. Although the double gate LCD is demonstrated in this specification, the present invention can be adapted, with or without modification, to other type of LCD, such as triple gate LCD, quadruple gate LCD, or multiple-fold gate LCD in general. FIG. 2B shows a timing diagram illustrating the driving sequence of the gate lines G1-G12 according to driving scheme in FIG. 2A. Accordingly, the gate lines G1-G12 of the double gate LCD are driven in the sequence of 1-2-3-4-6-5-8-7-9-10-11-12 as shown in FIG. 2B. FIG. 2C shows exemplary common electrode polarities according to the driving scheme of FIG. 2A. Compared to the driving scheme of FIG. 1C-1E, the bank driving sequence for the present has a pattern of AB-AB-BA-BA (instead of AB-AB-AB-AB in the previous driving scheme) for consecutive scan lines. In other words, the bank driving sequence reverses (from AB to BA or from BA to AB) every two scan lines. Accordingly, the gate lines of the double gate LCD are driven in the sequence of 1-2-3-4-6-5-8-7-9-10-11-12. Although the bank driving sequence reverses every two scan lines, the present invention can be, however, adaptably modified such that the bank driving sequence reverses, for example, every other scan line or every three scan lines.

Referring to FIG. 2C, the shaded pixels indicate the charge un-balance caused by the toggling common electrode voltage (Vcom). According to the specific driving scheme of this embodiment, it is noted that the lines with the same polarity have reversed bank driving sequence in the spatial domain (that is, in the same frame). For example, both the first line (“Line1”) and the third line (“Line3”) have the same polarity “+” in the first frame (“frame1”)), and thus the first line (“Line1”) has a bank driving sequence (AB) that is the reverse of the bank driving sequence (BA) of the third line (“Line3”). It is also noted that the lines with the same polarity have reversed bank driving sequence in the temporal domain (that is, in the different frame). For example, the first lines (“Line1”) of both the first frame (“frame1”) and the third frame (“frame3”) have the same polarity “+”, and thus the first line (“Line1”) of the first frame (“frame1”) has a bank driving sequence (AB) that is the reverse of the bank driving sequence (BA) of the first line of the third frame (“frame3”). Accordingly, each dot for the present has substantially the same probability of encountering the toggling common electrode voltage (Vcom), and the charge difference therefore happens on every dot. For example, with respect to the first dot R1 in the first line (“Line1”), it encounters the toggling common electrode voltage (Vcom) of positive polarity in the first frame (“frame1”); it encounters the toggling common electrode voltage (Vcom) of negative polarity in the second frame (“frame2”); it does not encounter the toggling common electrode voltage (Vcom) of positive polarity in the third frame (“frame3”); and finally, it does not encounter the toggling common electrode voltage (Vcom) of negative polarity in the fourth frame (“frame4”). As a whole, human eyes no longer perceive the defective vertical stripe visually. In the embodiment, the bank driving sequence and the reversal of the polarity of common electrode POL may be performed by the timing controller 20 (FIG. 1A) or the gate driver 16/18.

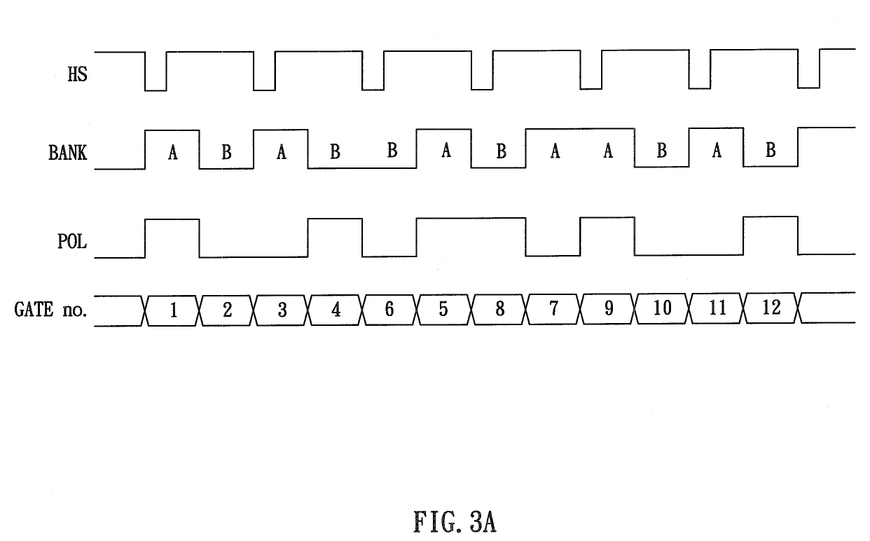

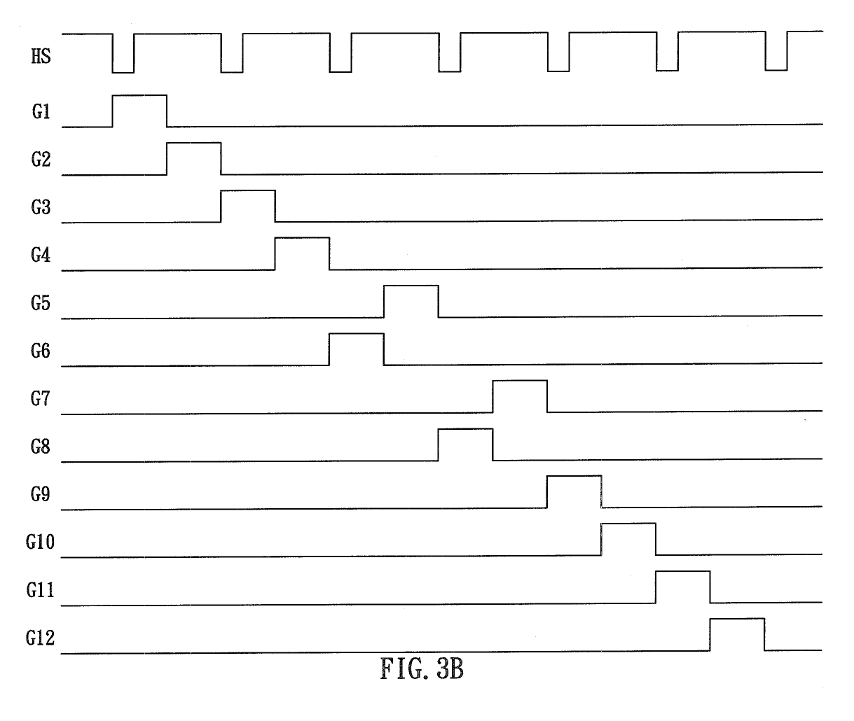

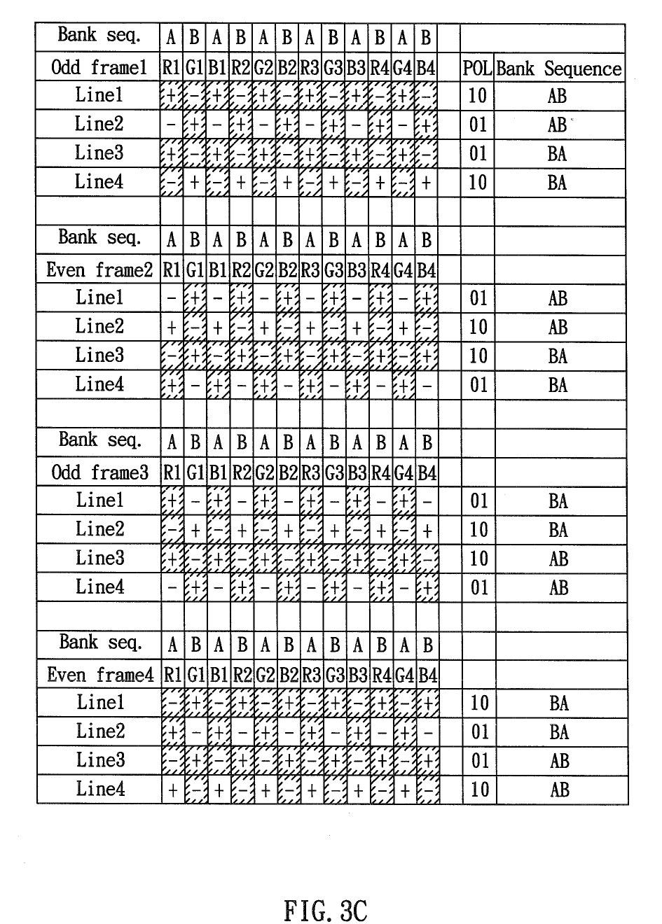

FIG. 3A shows a timing diagram illustrating the operation of a driving scheme according to another embodiment of the present invention. FIG. 3B shows a timing diagram illustrating the driving sequence of the gate lines G1-G12 according to driving scheme in FIG. 3A. Accordingly, the gate lines G1-G12 of the double gate LCD are driven in the sequence of 1-2-3-4-6-5-8-7-9-10-11-12 as shown in FIG. 3B. FIG. 3C shows exemplary common electrode polarities according to the driving scheme of FIG. 3A. In this embodiment, the polarity of the common electrode POL is arranged to arrive at a dot inversion (rather than the line inversion). That is, the polarity of the common electrode POL of a dot is opposite to that of a neighboring dot in the same frame. Furthermore, the polarity of the common electrode POL of a dot in a frame is also opposite to that of same dot in the neighboring frame. In the embodiment, the polarity of the common electrode POL changes in the middle of the horizontal scan (that is, at the time of ½*H). Compared to the driving scheme of FIG. 2A-2C, the bank driving sequence now has the same pattern of AB-AB-BA-BA for consecutive scan lines. In other words, the bank driving sequence reverses (from AB to BA or from BA to AB) every two scan lines. Accordingly, the gate lines of the double gate LCD are driven in the sequence of 1-2-3-4-6-5-8-7-9-10-11-12.

Referring to FIG. 3C, the shaded pixels indicate the charge un-balance caused by the toggling common electrode voltage (Vcom). According to the specific driving scheme of this embodiment, it is noted that each dot now has been substantially visually averaged both in temporal domain and spatial domain. For example, concerning the first frame (“frame1”), the first dot R1 in the first line (“Line1”) can be visually averaged with the first dot R1 in the third line (“Line3”) in the spatial domain (that is, in the same frame). Furthermore, the first line (“Line1”) in the first frame (“frame1”) can also be visually averaged with first line (“Line1”) in the third frame (“frame3”) in the temporal domain (that is, in the different frames). As a whole, human eyes no longer perceive the defective vertical stripe visually.

According to the embodiments disclosed above, as the double gate LCD is driven in a manner such that each dot has substantially the same probability of encountering the toggling common electrode voltage (Vcom), or each dot has been substantially visually averaged both in temporal domain and spatial domain, the defective vertical stripes could thus be effectively reduced or even eliminated.

Although specific embodiments have been illustrated and described, it will be appreciated by those skilled in the art that various modifications may be made without departing from the scope of the present invention, which is intended to be limited solely by the appended claims.

What is claimed is:

1. A method of driving a liquid crystal display (LCD), having at least two banks of pixel electrodes in each row that are driven in turn during a horizontal scan cycle, said method comprising:
driving the at least two banks of a first row with a first driving sequence; and
driving the at least two banks of a second row with a second driving sequence different from the first driving sequence.

2. The method of claim 1, wherein said first row and the second row are located in a same frame.

3. The method of claim 1, wherein said first row and the second row are located in different frames.

4. The method of claim 1, further comprising line inversing to spatially and temporally inverse polarity of common electrode of neighboring row.

5. The method of claim 4, wherein said first row has the same polarity as the second row.

6. The method of claim 1, further comprising dot inversing to spatially and temporally inverse polarity of common electrode of neighboring pixel.

7. The method of claim 6, wherein said polarity of the common electrode changes approximately in a middle of the horizontal scan cycle.

8. A method of driving a double gate liquid crystal display (LCD), said method comprising:
providing a horizontal synchronization signal to start a horizontal scan cycle;
providing a forward driving sequence for driving bank A and bank B of pixel electrodes in a plurality of rows; and
reversing the forward driving sequence to obtain a reverse driving sequence for driving the bank A and the bank B of pixel electrodes in a plurality of neighboring rows.

9. The method of claim 8, wherein said driving sequence is reversed every two rows.

10. The method of claim 8, wherein said driving sequence is reversed every two frames.

11. The method of claim 8, wherein said rows with the forward driving sequence and the rows with the reverse driving sequence are located in a same frame.

12. The method of claim 8, wherein said rows with the forward driving sequence and the rows with the reverse driving sequence are located in different frames.

13. The method of claim 8, further comprising line inversing to spatially and temporally inverse polarity of common electrode of neighboring row.

14. The method of claim 13, wherein a first row with the forward driving sequence has the same polarity as a second row with the reverse driving sequence.

15. The method of claim 8, further comprising dot inversing to spatially and temporally inverse polarity of common electrode of neighboring pixel.

16. The method of claim 15, wherein said polarity of the common electrode changes approximately in a middle of the horizontal scan cycle.

17. Apparatus for driving a multiple-fold gate liquid crystal display (LCD), having at least two banks of pixel electrodes in each row, said apparatus comprising:
means for providing a forward driving sequence for the at least two banks;
means for altering the forward driving sequence; and
at least one gate driver for driving a plurality of rows of pixel electrodes according to the forward driving sequence and the altered driving sequence in turn.

18. The apparatus of claim 17, wherein said providing means is included in a timing controller or the gate driver.

19. The apparatus of claim 17, wherein said altering means is included in a timing controller or the gate driver.

20. The apparatus of claim 17, further comprising line inversion means for spatially and temporally inversing polarity of common electrode of neighboring row.

21. The apparatus of claim 17, further comprising dot inversion means for spatially and temporally inversing polarity of common electrode of neighboring pixel.

22. A double gate liquid crystal display (LCD), comprising:
a plurality of rows and columns of pixel electrodes arranged in matrix form, each row having two banks of pixel electrodes;
means for providing a forward driving sequence for the two banks;
means for providing a reverse driving sequence for the two banks; and
at least one gate driver for driving a plurality of rows of pixel electrodes according to the forward driving sequence and the reverse driving sequence in turn.

23. The apparatus of claim 22, wherein said plurality of rows are driven either according to the forward driving sequence or the reverse driving sequence every two rows.

24. The apparatus of claim 22, wherein said plurality of rows are driven either according to the forward driving sequence or the reverse driving sequence every two frames.
